(19) United States
(12) Patent Application Publication
(10) Pub. No.: US 2010/0321282 A1
(43) Pub. Date: Dec. 23, 2010

(54) DISPLAY MODULE

(75) Inventors: Chia-Cheng Lai, Tainan County (TW); Tz-Ian Hung, Tainan County (TW); Hung-Yi Wang, Tainan County (TW)

Correspondence Address: J C PATENTS, 4 VENTURE, SUITE 250, IRVINE, CA, 92618, US

(73) Assignees: Himax Display, Inc., Tainan County (TW); HIMAX TECHNOLOGIES LIMITED, Tainan County (TW)

(21) Appl. No.: 12/612,879

(22) Filed: Nov. 5, 2009

Related U.S. Application Data
(60) Provisional application No. 61/218,084, filed on Jun. 18, 2009.

(51) Int. Cl. G09G 3/36

(52) U.S. Cl. 345/87

(57) ABSTRACT

A display module including a first circuit board, a display panel and at least a die is disclosed. The display panel is disposed on the first circuit board and electrically connected to the first circuit board through a bonding wire. The die is disposed on the first circuit board and electrically connected to the first circuit board.

### CROSS-REFERENCE TO RELATED APPLICATION

This application claims the priority benefit of U.S. provisional application Ser. No. 61/218,084, filed on Jun. 18, 2009. The entirety of the above-mentioned patent application is hereby incorporated by reference herein and made a part of this specification.

### BACKGROUND OF THE INVENTION

1. Field of the Invention

The present invention generally relates to a display module, and more particularly, to a modularized display module.

2. Description of Related Art

Along with the rapid progress of video technology, various display devices are developing towards miniaturization and even towards micronization. A display device usually has a display panel for displaying information, wherein the display panel is controlled by a circuit board. The display panel is operated through chips on the circuit board so as to provide digital signals to control the display effect of each pixel unit on the display panel and further to produce frames. To accomplish the above-mentioned operations, a flexible flat cable (FFC) or a flexible printed circuit (FPC) disposed between the circuit board and the display panel is used to make them electrically connected to each other. However, the above-mentioned conventional design makes the integral volume of the display device unable to be effectively downsized and thereby the display device fails to meet the requirement of micronization. In addition, the above-mentioned FFC or FPC for connecting the circuit board and the display panel to each other would raise the production cost of the display device and affect the production yield thereof.

### SUMMARY OF THE INVENTION

Accordingly, the present invention is directed to a display module with modularized design to largely downsize the integral volume of the display device and thereby achieve the micronization effect.

The present invention provides a display module, which includes a first circuit board, a display panel and at least a die. The display panel is disposed on the first circuit board and electrically connected to the first circuit board via a bonding wire. The die is disposed on and electrically connected to the first circuit board.

In an embodiment of the present invention, the above-mentioned display panel and the die are respectively disposed on two side-surfaces opposite to each other of the first circuit board.

In an embodiment of the present invention, the above-mentioned first circuit board has a first conductive through hole, the die is electrically connected to the display panel through the first conductive through hole.

In an embodiment of the present invention, the above-mentioned display panel and the die are disposed on a side-surface of the first circuit board, and the die is located between the display panel and the first circuit board.

In an embodiment of the present invention, the above-mentioned display module further includes a connector disposed on and electrically connected to the first circuit board.

In an embodiment of the present invention, the above-mentioned first circuit board has a first conductive through hole, the connector is electrically connected to the die through the first conductive through hole.

In an embodiment of the present invention, the above-mentioned display module further includes a molding compound to encapsulate the die and overlay a part of the first circuit board.

In an embodiment of the present invention, the above-mentioned display module further includes a connector disposed on the molding compound and electrically connected to the first circuit board.

In an embodiment of the present invention, the above-mentioned display module further includes a connector disposed on and electrically connected to the first circuit board.

In an embodiment of the present invention, the above-mentioned display module further includes a second circuit board, wherein the display panel and the die are respectively disposed on two side-surfaces opposite to each other of the first circuit board, and the die is located between the first circuit board and the second circuit board, wherein the die includes a first die and a second die. The first die is disposed on and electrically connected to the first circuit board, and the second die is disposed on and electrically connected to the second circuit board.

In an embodiment of the present invention, the above-mentioned first die and second die are respectively electrically connected to the first circuit board and the second circuit board by using wire bonding or flip chip bonding.

In an embodiment of the present invention, the above-mentioned display module further includes a molding compound filling the space between first circuit board and the second circuit board and encapsulating the first die and the second die.

In an embodiment of the present invention, the above-mentioned display module further includes a connector disposed on and electrically connected to the second circuit board.

In an embodiment of the present invention, the above-mentioned connector and the second die are respectively located on two side-surfaces opposite to each other of the second circuit board. The second circuit board has a second conductive through hole, and the connector is electrically connected to the second die through the second conductive through hole.

In an embodiment of the present invention, the above-mentioned die is electrically connected to the first circuit board by using wire bonding or flip chip bonding.

In an embodiment of the present invention, the above-mentioned display panel includes liquid crystal on silicon panel (LCOS panel), digital micro-mirror device panel (DMD panel), liquid crystal device panel (LCD panel) or digital light processing panel (DLP panel).

Based on the description above, since the display module of the present invention takes a modularized design to integrate the display panel and the die on the circuit board, so that the integral volume of the display module is largely downsized to achieve the micronization effect. In addition, in the display module of the present invention, there is no need to employ an FFC or an FPC to make the circuit board and the display panel connected to each other, so that, in comparison with the prior art, the display module of the present invention can effectively reduce the production cost and have better reliability.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a cross-sectional diagram of a display module of an embodiment of the present invention.

FIG. 2 is a cross-sectional diagram of a display module of another embodiment of the present invention.

FIG. 3 is a cross-sectional diagram of a display module of yet another embodiment of the present invention.

FIG. 4 is a cross-sectional diagram of a display module of yet another embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

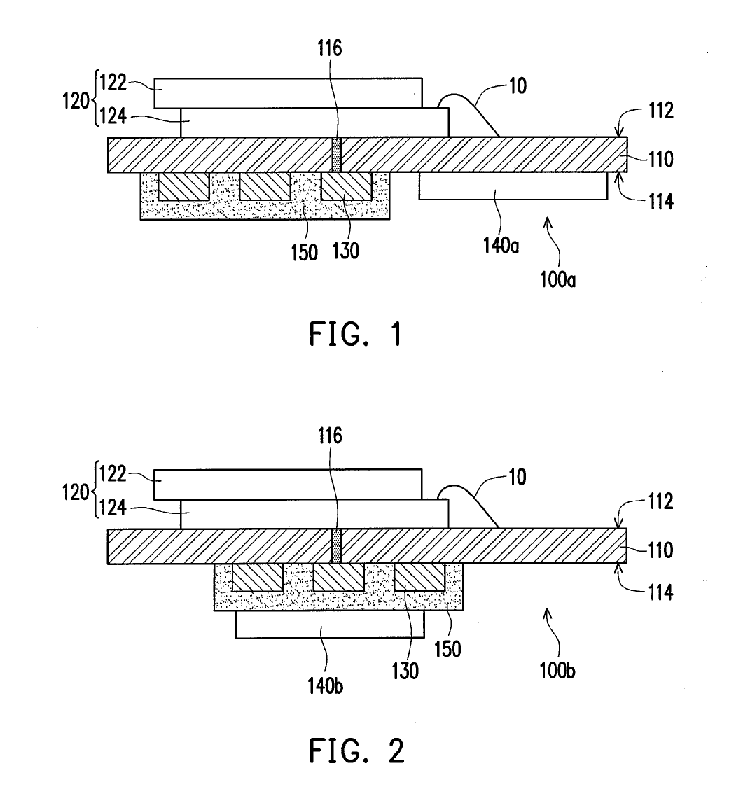

FIG. 1 is a cross-sectional diagram of a display module of an embodiment of the present invention. Referring to FIG. 1, a display module 100a includes a first circuit board 110, a display panel 120 and at least a die 130 (in FIG. 1, only three dies are exemplarily shown). The first circuit board 110 can be a flexible circuit board, a printed circuit board, or a rigid-flex circuit board, which the present invention is not limited to.

In more details, the display panel 120 and the die 130 are respectively disposed on two side-surfaces opposite to each other of the first circuit board 110, i.e., the display panel 120 is located on a surface 112 of the first circuit board 110 and the die 130 is located on another surface 114 of the first circuit board 110. The display panel 120 is electrically connected to the first circuit board 110 via a bonding wire 10, which means the display panel 120 is electrically connected to the first circuit board 110 by using wire bonding. The first circuit board 110 has a first conductive through hole 116, and the die 130 is electrically connected to the display panel 120 through the first conductive through hole 116.

The display panel 120 is, for example, LCOS panel, DMD panel, LCD panel or DLP panel. In the embodiment, the display panel 120 includes a first substrate 122 and a second substrate 124, wherein the first substrate 122 is, for example, glass substrate and the second substrate 124 is, for example, silicon substrate made of semiconductor material. In other words, the display panel 120 of the embodiment is, for example, an LCOS panel, which the present invention is not limited to.

The die 130 includes a memory unit (not shown), a sensing unit (not shown), a heating unit (not shown) and a driving unit (not shown), wherein the die 130 can be electrically connected to the first circuit board 110 by using wire bonding or flip chip bonding. In other words, the die 130 can communicate with the display panel 120 for delivering or receiving signals through the first conductive through hole 116 or the layout on the first circuit board 110.

Since the display module 100a of the embodiment takes a modularized design to integrate the display panel 120 and the die 130 into on the first circuit board 110, so that the integral volume of the display module 100a is largely downsized and the micronization effect is achieved. In addition, in the display module 100a of the embodiment, the display panel 120 is electrically connected to the first circuit board 110 by using wire bonding, and it should be noted that the die 130 is electrically connected to the first circuit board 110 by using wire bonding or flip chip bonding, hence in comparison with the prior art where the circuit board and the display panel are connected to each other by using an FFC or an FPC, the display module 100a of the embodiment can effectively reduce the production cost and have better reliability.

In the embodiment, the display module 100a further includes a connector 140a and a molding compound 150. The connector 140a is disposed on the first circuit board 110, and the connector 140a and the display panel 120 are respectively located on two side-surfaces 112 and 114 opposite to each other of the first circuit board 110. In more details, the connector 140a is located on the surface 114, the connector 140a is electrically connected to the first circuit board 110, and the display module 100a can be electrically connected to an external circuit (not shown) through the connector 140a. In short, the display module 100a of the embodiment has the connector 140a, through which the first circuit board 110 is electrically connected to an external circuit. The above-mentioned design can win more applications of the display module 100a. The molding compound 150 encapsulates the die 130 and overlays a part of the first circuit board 110 so as to protect the die 130 from being affected by external temperature, moisture and noise.

It should be noted that the present invention does not limit the position of the connector 140a. Although as mentioned above, the connector 140a is disposed on the surface 114 of the first circuit board 110, however in other unshown embodiments, the connector 140a can be disposed on the surface 112 of the first circuit board 110. In fact, the location of the connector 140a in FIG. 1 is an example only, which the present invention is not limited to.

In addition, in other unshown embodiments, the display module 100a also can be electrically connected to the external circuit by using flexible printed circuit instead of the connector 140a, which still belongs to means of the present invention and does not depart from the scope of the present invention.

Several different embodiments are depicted hereinafter to respectively explain the designs of the display modules 100b-100d. In the following embodiments, the same reference numbers and partial same descriptions as the mentioned above are used refer to the same or like parts, and meanwhile, the duplicate contents are omitted. All the omitted descriptions can refer to the above-mentioned embodiment.

FIG. 2 is a cross-sectional diagram of a display module of another embodiment of the present invention. Referring to FIGS. 1 and 2, the display module 100b in FIG. 2 is similar to the display module 100a in FIG. 1 except that the connector 140b in the display module 100b of FIG. 2 has a different disposing position. In more details, the connector 140b is disposed on the molding compound 150, and the connector 140b and the first circuit board 110 are electrically connected to each other. In the embodiment, the connector 140b can be electrically connected to the first circuit board 110 through a conductive connection structure (not shown), wherein the conductive connection structure can be, for example, a conductive through hole structure going through the molding compound 150 or a wire directly connected between the first circuit board 110 and the connector 140b. In other words, the embodiment does not limit the electrical connection architecture between the connector 140b and the first circuit board 110. Anyone skilled in the art can, as per the discretion of his own, define a conductive connection structure to electrically connect the first circuit board 110 to the connector 140b according to the practical requirement.

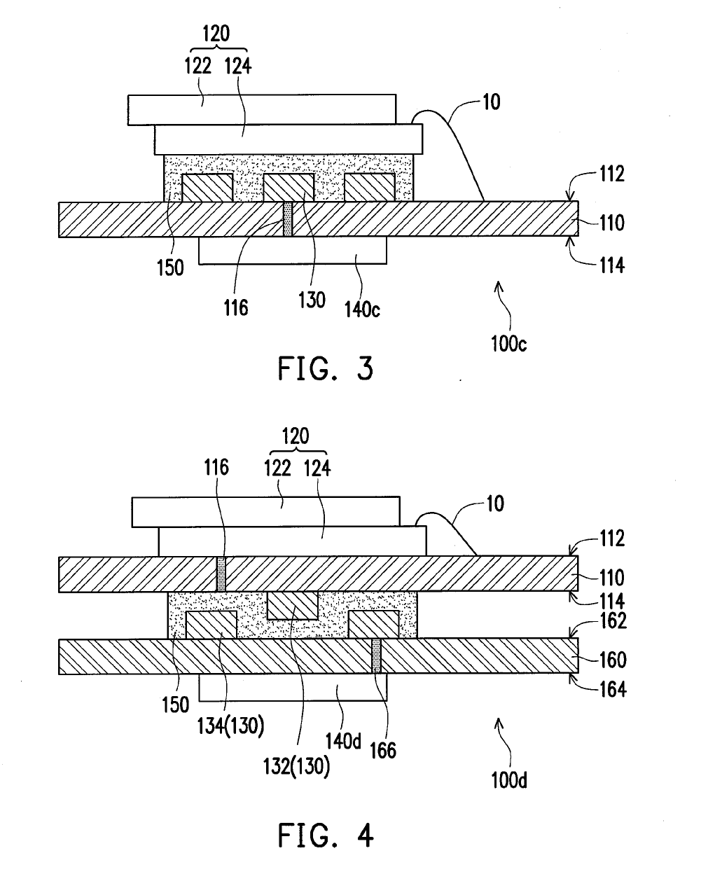

FIG. 3 is a cross-sectional diagram of a display module of yet another embodiment of the present invention. Referring to FIGS. 1 and 3, the display module 100c in FIG. 3 is similar to the display module 100a in FIG. 1 except that the die 130 of the display module 100c in FIG. 3 has a different disposing position. In more details, both the display panel 120 and the die 130 are disposed on the surface 112 of the first circuit board 110, and the die 130 is located between the display panel 120 and the first circuit board 110. The die 130 and the connector 140c are respectively located on the two side-surfaces 112 and 114 opposite to each other of the first circuit board 110, and the connector 140c can be electrically connected to the die 130 through the layout (not shown) on the first circuit board 110 or the first conductive through hole 116.

FIG. 4 is a cross-sectional diagram of a display module of yet another embodiment of the present invention. Referring to FIGS. 1 and 4, the display module 100d in FIG. 4 is similar to the display module 100a in FIG. 1 except that the display module 100d of FIG. 4 further includes a second circuit board 160, and the disposing positions of the die 130 and the connector 140d are different. In more details, both the display panel 120 and the die 130 are respectively disposed on the two side-surfaces 112 and 114 opposite to each other of the first circuit board 110, and the die 130 is located between the first circuit board 110 and the second circuit board 160. The second circuit board 160 can be a flexible circuit board, a printed circuit board, or a rigid-flex circuit board, which the present invention is not limited to.

In the embodiment, the die 130 includes a first die 132 and two second dies 134. The first die 132 is disposed on the surface 114 of the first circuit board 110 and electrically connected to the first circuit board 110. The second dies 134 are disposed on a surface 162 of the second circuit board 160 and electrically connected to the second circuit board 160. The first die 132 and the second dies 134 are respectively electrically connected to the first circuit board 110 and the second circuit board 160 by using wire bonding or flip chip bonding. With the molding compound 150, the space between the first circuit board 110 and the second circuit board 160 is filled and the molding compound 150 encapsulates the first die 132 and the second dies 134 so as to protect the first die 132 and the second dies 134. The connector 140d is disposed on another surface 164 of the second circuit board 160 and used to electrically connect the external circuit (not shown). The second circuit board 160 has a second conductive through hole 166, and the connector 140d is electrically connected to the second dies 134 through the second conductive through hole 166.

It should be noted that although the above-mentioned first die 132 is exemplarily one die and the second dies 134 are exemplarily two dies, but in other unshown embodiments, the numbers of the first die 132 and the second die 134 can be other than the mentioned above according to the practical requirement, which the present invention is not limited to.

In summary, since the display module of the present invention takes a modularized design to integrate the display panel and the die on the circuit board, so that the integral volume of the display module is largely downsized to achieve the micronization effect. In addition, in the display module of the present invention, the display panel is electrically connected to the circuit board by using wire bonding, while the die is electrically connected to the circuit board by using wire bonding or flip chip bonding. In comparison with the prior art where the display panel is electrically connected to the circuit board though an FFC or an FPC, the display module of the present invention can effectively reduce the production cost and have better reliability. In addition, the display module of the present invention has a connector so that the circuit board can be electrically connected to an external circuit through the connector, which is advantageous in wider applications.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A display module, comprising:
a first circuit board;
a display panel, disposed on the first circuit board and electrically connected to the first circuit board via a bonding wire; and
at least one die, disposed on and electrically connected to the first circuit board.

2. The display module as claimed in claim 1, wherein the display panel and the at least one die are respectively disposed on two side-surfaces opposite to each other of the first circuit board.

3. The display module as claimed in claim 2, wherein the first circuit board has a first conductive through hole, the at least one die is electrically connected to the display panel through the first conductive through hole.

4. The display module as claimed in claim 1, wherein the display panel and the at least one die are disposed on a side-surface of the first circuit board, and the at least one die is located between the display panel and the first circuit board.

5. The display module as claimed in claim 4, further comprising a connector disposed on and electrically connected to the first circuit board.

6. The display module as claimed in claim 5, wherein the first circuit board has a first conductive through hole, the connector is electrically connected to the at least one die through the first conductive through hole.

7. The display module as claimed in claim 1, further comprising a molding compound to encapsulate the at least one die and overlay a part of the first circuit board.

8. The display module as claimed in claim 7, further comprising a connector disposed on the molding compound and electrically connected to the first circuit board.

9. The display module as claimed in claim 1, wherein further comprising a connector disposed on and electrically connected to the first circuit board.

10. The display module as claimed in claim 1, further comprising a second circuit board, wherein the display panel and the at least one die are respectively disposed on two side-surfaces opposite to each other of the first circuit board, and the at least one die is located between the first circuit board and the second circuit board, wherein the at least one die comprises a first die and a second die, the first die is disposed on and electrically connected to the first circuit board, and the second die is disposed on and electrically connected to the second circuit board.

11. The display module as claimed in claim 10, wherein the first die and the second die are respectively electrically connected to the first circuit board and the second circuit board by using wire bonding or flip chip bonding.

12. The display module as claimed in claim 10, further comprising a molding compound filling the space between first circuit board and the second circuit board and encapsulating the first die and the second die.

13. The display module as claimed in claim 10, further comprising a connector disposed on and electrically connected to the second circuit board.

14. The display module as claimed in claim 13, wherein the connector and the second die are respectively located on two side-surfaces opposite to each other of the second circuit board, the second circuit board has a second conductive through hole, and the connector is electrically connected to the second die through the second conductive through hole.

15. The display module as claimed in claim 1, wherein the at least one die is electrically connected to the first circuit board by using wire bonding or flip chip bonding.

16. The display module as claimed in claim 1, wherein the display panel comprises liquid crystal on silicon panel, digital micro-mirror device panel, liquid crystal device panel or digital light processing panel.
